(19) United States
(12) Patent Application Publication
(10) Pub. No.: US 2005/0082133 A1
(43) Pub. Date: Apr. 21, 2005

(54) Rail based electric power distribution network

(76) Inventor: Sergio Panetta, Mississauga (CA)

Correspondence Address: SMART AND BIGGAR, 438 UNIVERSITY AVENUE, SUITE 1500 BOX 111, TORONTO, ON, M5G2K8, CA

(21) Appl. No.: 10/687,760

(22) Filed: Oct. 20, 2003

(51) Int. Cl. B60L 1/00

(52) U.S. Cl. 191/2

(57) ABSTRACT

A train including a multi-phase electrical distribution network permitting easy detection and location of ground faults, and a method of detecting a ground fault on such a train are disclosed. Net current tapped at each of the cars is sensed. In the event the net current tapped at a car does not equal zero, an alarm signifying a ground fault at that car is triggered. In this way, ground faults on the train may be easily located and serviced.

### FIELD OF THE INVENTION

The present invention relates generally to rail vehicles, and more particularly to trains including mobile power distribution networks.

### BACKGROUND OF THE INVENTION

In today's world electricity is required nearly everywhere. In many mobile transport vehicles electricity is used to power auxiliary equipment such as air conditioners, lighting and heaters. Rail based vehicles, such as trains moved by diesel or similar locomotives, for example, typically include an electric generator that generates electricity that is distributed by way of a modular distribution network to cars on the train.

In such an environment, electricity is generated on the moving vehicle and distributed by way of a mobile distribution network. At each electricity consuming car, electricity is tapped and consumed.

Because such a distribution network is modular, and electric power is consumed at many locations, faults are difficult to locate. In conventional trains such faults are located by elimination. The fault is initially detected at the generator. After its detection, cars are systematically disconnected from the mobile network until the location of the fault is isolated. This, however, is time consuming and labour intensive.

Clearly then, there is a need for a method of detecting a fault on a rail transport vehicle having a modular electric distribution system, and an improved rail transport vehicle allowing easy electric fault detection on an associated distribution network.

### SUMMARY OF THE INVENTION

In accordance with the present invention multi-phase electric power is distributed in a train. The train includes a plurality of cars, each of which includes a wiring harness for interconnection to an adjacent car to distribute multi-phase electric power. The method includes generating the multiphase electric power; providing the multiphase electric power to a power distribution network formed of a plurality of such wiring harnesses; tapping multiphase power from the power distribution network at at least one of the cars for consumption at the at least one of the cars; sensing net current tapped at the at least one of the cars; and triggering an alarm if the net current tapped at the at least one of the cars does not equal zero, signifying a ground fault at the at least one car.

A train exemplary of the invention includes, a locomotive; a plurality of cars; a multi-phase electric generator; an electrical distribution network extending from the electric generator to the plurality of cars; at least one of the cars comprising a power providing conductors for providing multi-phase electric power to an electric load on the car; and a ground fault sensor interconnected with the power providing conductors for sensing and indicating a ground fault at the at least one of the cars.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is an elevational view of a train including a distribution system exemplary of embodiments of the present invention;

FIG. 2 is a top plan view of the train of FIG. 1;

FIG. 3 is a schematic diagram of portions of the distribution system of FIG. 1; and

FIG. 4 is a schematic diagram of a ground fault detection circuit, used in the train of FIG. 1.

### DETAILED DESCRIPTION

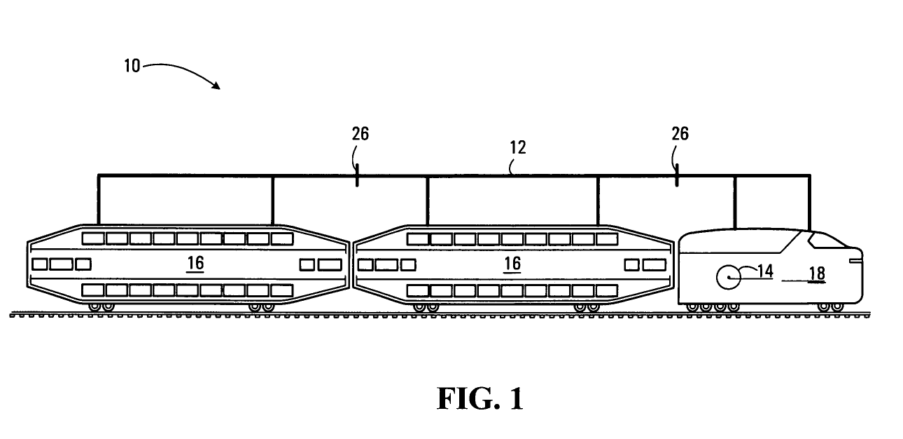

FIG. 1 illustrates a rail borne vehicle in the form of train 10, including an electrical distribution network 12, exemplary of an embodiment of the present invention. As illustrated, train 10 includes a locomotive 18 and a plurality of towed cars 16. The train 10 may, for example, be a passenger train, with cars 16 suited for passenger transport.

Locomotive 18 includes a conventional engine (not specifically illustrated) that may, for example, be a diesel engine. In the described embodiment, a generator 14 for generating electricity used to power auxiliary equipment on train 10 is located within locomotive 18. Electric power generated by generator 14 is distributed throughout train 10 by way of a mobile electric power distribution network 12.

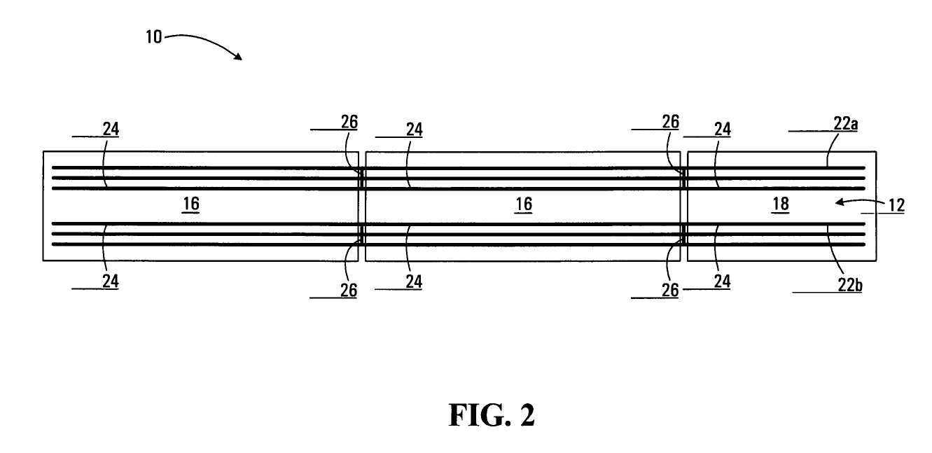

Train 10 is illustrated in top plan view in FIG. 2. Specifically, distribution network 12 is a three phase distribution network that extends along the top of train 10. In the disclosed embodiment, distribution network 12 includes a left and right set of three length-wise extending conductors 22a and 22b. Each of the length-wise extending conductors transports one phase of three-phase electric power from generator 14 to each of cars 16. Network 12 is modular, in that each car includes two sets of three conductor harnesses 24 (a left and right harness), terminated at each end by a connector 26. Connectors of adjacent cars may be interconnected so that network 12 may extend from the front to the rear of train 10 providing electric power to each car 16. As new cars are added to train 10, harnesses 24 of such cars may be interconnected to an existing network 12.

In order to limit the power required to be carried by each harness 24, by each set of conductors 22a or 22b, and through connectors 26, two separate three-phase distribution harnesses 24 are provided on each car 16. In this way, the total power delivered to each of cars 16 may be delivered by two sets of conductors 22a and 22b, each only needing to carry half the current required by a single set of conductors.

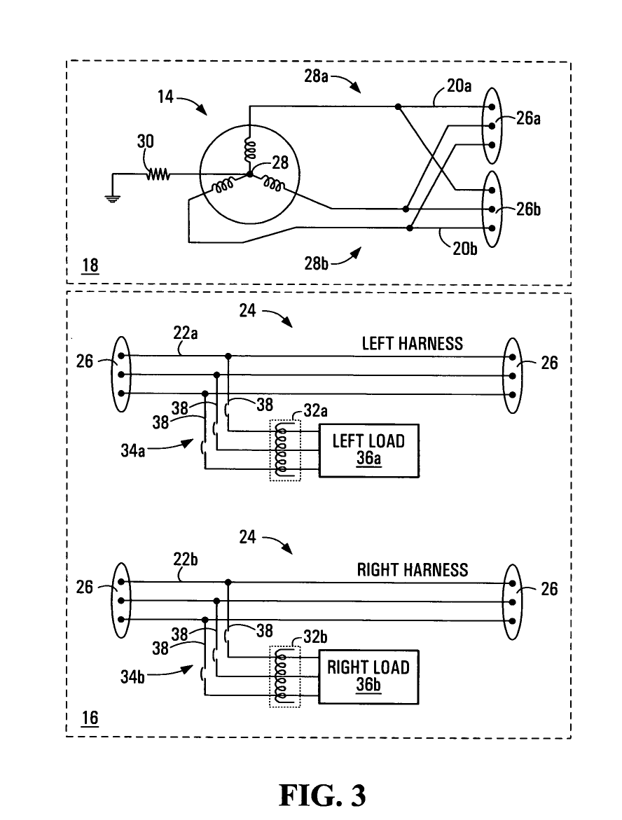

Portions of distribution network 12 and generator 14 are schematically illustrated in FIG. 3. As illustrated, generator 14 provides two three-phase feeds, 20a and 20b. In the disclosed embodiment, generator 14 is WYE-connected. A centre tap 28 of generator 14 is connected to ground by way of ground-fault limiting impedance 30. Ground limiting impedance 30 is preferably sufficiently large to limit ground fault current, preferably to 5A or less. The two three phase feeds 20a and 20b emanating from generator 14 terminate at connectors 26a and 26b, respectively.

The portion of electric distribution network 10 of a single rail car 16 is similarly schematically depicted in FIG. 3. As illustrated, each car is equipped with a left and right harness 24. Two connectors 26 allow the interconnection of each harness 24 including conductors 22a or 22b spanning the length of car 16 to connectors 26 of a harness 24 of an adjacent car 16 or to connectors 26a and 26b of locomotive 18.

Conductors 22a and 22b of each of harnesses 24 extending along the length of the car may be tapped by three-phase power providing conductors 34a and 34b. Each of these feeds one of electrical loads 36a and 36b. Loads 36a and 36b may, for example, be heaters, air conditioners, lights, or similar electrical equipment used in rail car 16.

In order to limit the current provided to load 36a/36b by way of power providing conductors 34a and 34b, these are preferably fused or fed through circuit breakers. As illustrated, one current limiter 38, for example in the form of a circuit breaker or fuse, fuses each phase of the provided three-phase power, provided by way of left or right harnesses 24.

Additionally, exemplary of an embodiment of the present invention, ground fault detection circuits 32a and 32b (individually a ground fault detection circuit 32) are provided to detect ground faults caused by a load connected by way of power providing conductors 34a to left harness 24 or by way of power providing conductors 34b connected to right harness 24.

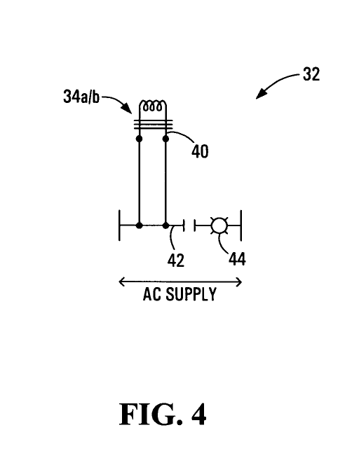

As illustrated in FIG. 4, each ground fault detection circuit 32 includes a current sensor 40, preferably in the form of a current-sensing transformer, and a conventional ground fault relay 42, in the form of a DGF digital ground fault relay, interconnected in series with a ground fault indicator 44. Ground fault indicator 44 is preferably a light. The series combination of relay 42 and indicator 44 are connected between a potential source which may for example be tapped from one of the phases of power providing conductors 34a or 34b. An identical ground fault detection circuit 32b is interconnected with tap 24b.

In operation, generator 14 generates three-phase electrical power. Generator 14 may be driven by the engine within locomotive 18 or by another suitable locomotive force. In the absence of any ground faults along distribution system 12, generator 14 will be balanced; that is, the total current provided by the three-phase output of generator 14 will sum to zero. As such, no current will flow through ground fault-limiting resistor 30. Generated electricity is provided along conductors 22a and 22b, with one phase of each the three phases provided along a single conductor. As a result of the electrical interconnection of cars 16, the generated power is propagated along conductors 22a and 22b and along train 10.

Within each rail car 16, power is tapped from conductors 22a and 22b by power providing conductors 34a and 34b, depicted in FIG. 3. In the absence of any ground fault along any power providing conductors 34a or 34b, the net current flowing through all three phases of any one set of power providing conductors 34a and 34b will also be zero. As a result, the current through sensor 40 of each ground fault detection circuit 32 will be zero.

In the presence of a ground fault anywhere along network 12, generator 14 will become unbalanced and a current reflecting the ground fault will flow through ground fault resistor 30. Conventionally, such a ground fault may be difficult to locate or isolate. Advantageously, ground fault in any of car 16 results in detection of the ground fault at power providing conductors 34a or 34b, as the net current flowing through an associated sensor 40 of ground fault-detection circuit 32a or 32b will no longer be zero.

As a result, current through sensor 40 will trip the associated ground fault relay 42 causing it to close. In response, the associated ground fault indicator 44 will be illuminated. As each car 16 includes a separate ground fault detection circuit 32 for each of its power providing conductors 34a or 34b, a ground fault may be easily located and isolated.

Preferably, two ground fault indicators 44 (one for the right load, the other for the left load) are located in the panel box of each car. In the presence of a ground fault, an operator may simply inspect the ground fault indicator 44 on each car, thereby allowing for quick detection and location of a ground fault. Complex isolation of ground faults on train 10 is no longer required.

As should be appreciated, multiple ground fault indicators 44 could be replaced remotely located at a single location. Remotely located ground fault indicators could be signalled through a suitable wired or wireless communications network. Optionally, ground faults could be logged using general purpose computing equipment suitably adapted to perform such logging. Similarly, ground fault detection circuit 32 could be replaced by a conventional ground fault detection circuit, as for example available from IPC Resistors under model number MGFR 20-ZB, or the like. In a further alternate embodiment, the ground fault detection circuit could optionally include a circuit breaker in series with conductors 34a/34b to limit the flow of current to any car having a detected ground fault.

Of course, the above described embodiments, are intended to be illustrative only and in no way limiting. The described embodiments of carrying out the invention, are susceptible to many modifications of form, arrangement of parts, details and order of operation. The invention, rather, is intended to encompass all such modification within its scope, as defined by the claims.

1. A method of distributing multi-phase electric power in a train, said train comprising a plurality of cars, each of said cars comprising a wiring harness for interconnection to an adjacent car to distribute said multi-phase electric power, said method comprising:
generating said multiphase electric power;
providing said multiphase electric power to a power distribution network formed of a plurality of said wiring harnesses;
tapping multiphase power from said power distribution network at at least one of said cars for consumption at said at least one of said cars;
sensing net current tapped at said at least one of said cars;
triggering an alarm if said net current tapped at said at least one of said cars does not equal zero, signifying a ground fault at said at least one car.

2. The method of claim 1, wherein said triggering comprises illuminating a light indicative of a ground fault.

3. The method of claim 1, wherein said generating comprises generating three-phase electrical power.

4. The method of claim 2, wherein said distribution system comprises two parallel set of multi-phase conductors, extending along a length of said train.

5. A train comprising:
a locomotive;
a plurality of cars;
a multi-phase electric generator;
an electrical distribution network extending from said electric generator to said plurality of cars;
at least one of said cars comprising power providing conductors forming part of said electrical distribution network, for providing multi-phase electric power to an electric load on said car;
a ground fault sensor interconnected with said power providing conductors for sensing and indicating a ground fault at said at least one of said cars.

6. The train of claim 5, wherein said ground fault sensor comprises a transformer to sense a net current delivered through said power providing conductors.

7. The train of claim 6, wherein said ground fault circuit further comprises an alarm indicator, for indicating an alarm in the event said net current does not equal zero.

8. The train of claim 7, wherein said alarm indicator comprises a light located in said at least one of said cars.

9. The train of claim 7, wherein said multi-phase generator comprises a three-phase generator.

10. The train of claim 9, wherein said distribution network comprises a plurality of interconnected wiring harnesses, extending between said cars.

11. The train of claim 9, wherein said distribution network comprises two sets of parallel wiring harnesses, extending between said cars, and said power providing conductors extend from one of said sets of parallel wiring harnesses.
